(19) United States
(12) Patent Application Publication
(10) Pub. No.: US 2014/0089755 A1
(43) Pub. Date: Mar. 27, 2014

(54) RELIABILITY ENHANCEMENTS FOR HIGH SPEED MEMORY - PARITY PROTECTION ON COMMAND/ADDRESS AND ECC PROTECTION ON DATA

(71) Applicants: Shveta KANTAMSETTI, Fremont, CA (US); Antonio JUAN, Barcelona (ES); Hoi M. NG, San Ramon, CA (US); Warren R. MORROW, Steilacoom, WA (US); Isaac HERNANDEZ, Barcelona (ES); Pau CABRE, Reus (ES); Thomas S. NG, Santa Clara, CA (US); Tsun Ho LIU, Fremont, CA (US); Rongchun SUN, Los Altos, CA (US); Jessica LEUNG, San Jose, CA (US); Mohamedsha MALIKANSARI, Fremont, CA (US); Henry STRACOVSKY, Portland, OR (US)

(72) Inventors: Shveta KANTAMSETTI, Fremont, CA (US); Antonio JUAN, Barcelona (ES); Hoi M. NG, San Ramon, CA (US); Warren R. MORROW, Steilacoom, WA (US); Isaac HERNANDEZ, Barcelona (ES); Pau CABRE, Reus (ES); Thomas S. NG, Santa Clara, CA (US); Tsun Ho LIU, Fremont, CA (US); Rongchun SUN, Los Altos, CA (US); Jessica LEUNG, San Jose, CA (US); Mohamedsha MALIKANSARI, Fremont, CA (US); Henry STRACOVSKY, Portland, OR (US)

(21) Appl. No.: 13/629,144

(22) Filed: Sep. 27, 2012

(51) Int. Cl. G06F 11/10; H04L 1/08

(52) U.S. Cl. 714/748; 714/805; 714/763; 714/E11.053

(57) ABSTRACT

Method and apparatus to efficiently detect/correct memory errors. A command and an address associated with a data transaction may be received. Parity information associated with the command/address may be received. In response to detecting a parity error, a data array of a memory device may be locked. An indicator indicating the parity error may be sent. A first portion of a memory page to store data may be reserved. A second portion of the memory page to store error correction codes associated with the data may be reserved. The second portion's size may equal or exceed the error correction code capacity needed for the maximum possible data stored in the first portion. A cache line of data may be stored in the first portion. An error correction code associated with the cache line of data may be stored in the second portion.

### FIELD OF THE INVENTION

The present disclosure pertains to the field of processors and, in particular, to optimizing memory/storage management techniques.

### DESCRIPTION OF RELATED ART

Advances in semi-conductor processing and logic design have permitted an increase in the amount of logic that may be present on integrated circuit devices. As a result, computer system configurations have evolved from a single or multiple integrated circuits in a system to multiple cores, multiple hardware threads, and multiple logical processors present on individual integrated circuits. A processor or integrated circuit typically comprises a single physical processor die, where the processor die may include any number of cores, hardware threads, or logical processors. The ever increasing number of processing elements—cores, hardware threads, and logical processors—on integrated circuits enables more tasks to be accomplished in parallel. However, the execution of more threads and tasks put an increased premium on shared resources, such as memory/cache and the management thereof.

Certain high speed memories do not include robust error detection and correction mechanisms because they were utilized in error tolerant applications such as graphics applications. Although other applications such as high performance computing (HPC) servers may benefit from the performance of high speed memories, these applications may require higher reliability in terms of error detection and correction in the high speed memories.

### DESCRIPTION OF THE FIGURES

Embodiments are illustrated by way of example and not limitation in the Figures of the accompanying drawings:

FIG. 1 illustrates a processor including multiple processing elements according to an embodiment.

FIG. 2 illustrates on-core memory interface logic according to an embodiment.

FIG. 3 illustrates a block diagram of a memory controller and memory according to an embodiment.

FIG. 4 illustrates a memory controller and memory according to an embodiment.

FIG. 5 illustrates a page from a memory bank in a non-clamshell memory data array according to an embodiment.

FIG. 6 illustrates a page from a memory bank in a clamshell memory data array according to an embodiment.

FIG. 7 illustrates a chart comparing a sequence of commands issued to access data from memory according to an embodiment and another access method.

FIG. 8 illustrates a chart comparing memory operations in open page mode and hybrid open page mode according to an embodiment.

FIG. 9 is a block diagram of an exemplary computer system according to an embodiment.

### DETAILED DESCRIPTION

In the following description, numerous specific details are set forth such as examples of specific hardware structures for storing/caching data, as well as placement of such hardware structures; specific processor units/logic, specific examples of processing elements, etc. in order to provide a thorough understanding of the present invention. It will be apparent, however, to one skilled in the art that these specific details need not be employed to practice the present invention. In other instances, well known components or methods, such as specific counter circuits, alternative multi-core and multi-threaded processor architectures, specific uncore logic, specific memory controller logic, specific cache implementations, specific cache coherency protocols, specific cache algorithms, specific error correction code algorithms, and specific operational details of microprocessors, have not been described in detail in order to avoid unnecessarily obscuring the present invention.

Embodiments may be discussed herein which efficiently detect and/or correct errors to boost memory reliability. In an embodiment, a command and an address associated with a data transaction may be received. Parity information associated with the command and/or address may be received. In response to detecting a parity error based on the parity information, a data array of a memory device may be locked. An indicator indicating the parity error may be sent.

In an embodiment, in response to receiving an inverted cyclic redundancy check code of a data transaction, processing of incoming data transactions may be halted. A command address parity error unlock command may be sent. The data transaction may be re-sent.

In an embodiment, a first portion of a memory page to store data may be reserved. A second portion of the memory page to store error correction codes associated with the data may be reserved. The second portion's size may equal or exceed the error correction code capacity needed for the maximum possible data stored in the first portion. A cache line of data may be stored in the first portion. An error correction code associated with the cache line of data may be stored in the second portion.

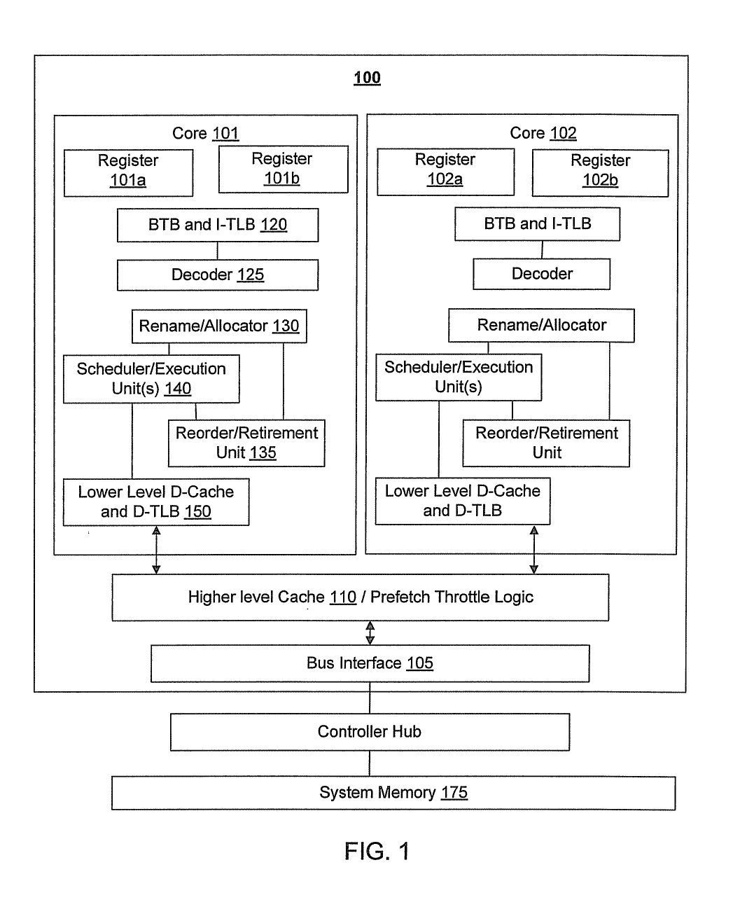

Referring to FIG. 1, an embodiment of a processor including multiple cores is illustrated. Processor 100, in one embodiment, includes one or more caches. Processor 100 includes any processor, such as a micro-processor, an embedded processor, a digital signal processor (DSP), a network processor, or other device to execute code. Processor 100, as illustrated, includes a plurality of processing elements.

In one embodiment, a processing element refers to a thread unit, a thread slot, a process unit, a context, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor typically refers to an integrated circuit, which potentially includes any number of other processing elements, such as cores or hardware threads.

A core often refers to logic located on an integrated circuit capable of maintaining an independent architectural state wherein each independently maintained architectural state is associated with at least some dedicated execution resources. In contrast to cores, a hardware thread typically refers to any logic located on an integrated circuit capable of maintaining an independent architectural state wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores, core 101 and 102. Here, core hopping may be utilized to alleviate thermal conditions on one part of a processor. However, hopping from core 101 to 102 may potentially create the same thermal conditions on core 102 that existed on core 101, while incurring the cost of a core hop. Therefore, in one embodiment, processor 100 includes any number of cores that may utilize core hopping. Furthermore, power management hardware included in processor 100 may be capable of placing individual units and/or cores into low power states to save power. Here, in one embodiment, processor 100 provides hardware to assist in low power state selection for these individual units and/or cores.

Although processor 100 may include asymmetric cores, i.e. cores with different configurations, functional units, and/or logic, symmetric cores are illustrated. As a result, core 102, which is illustrated as identical to core 101, will not be discussed in detail to avoid repetitive discussion. In addition, core 101 includes two hardware threads 101a and 101b, while core 102 includes two hardware threads 102a and 102b. Therefore, software entities, such as an operating system, potentially view processor 100 as four separate processors, i.e. four logical processors or processing elements capable of executing four software threads concurrently.

Here, a first thread is associated with architecture state registers 101a, a second thread is associated with architecture state registers 101b, a third thread is associated with architecture state registers 102a, and a fourth thread is associated with architecture state registers 102b. As illustrated, architecture state registers 101a are replicated in architecture state registers 101b, so individual architecture states/contexts are capable of being stored for logical processor 101a and logical processor 101b. Other smaller resources, such as instruction pointers and renaming logic in rename allocater logic 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register, low level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, processor 100 includes a branch target buffer 120 to predict branches to be executed/taken and an instruction-translation buffer (I-TLB) 120 to store address translation entries for instructions.

Processor 100 further includes decode module 125 is coupled to fetch unit 120 to decode fetched elements. In one embodiment, processor 100 is associated with an Instruction Set Architecture (ISA), which defines/specifies instructions executable on processor 100. Here, often machine code instructions recognized by the ISA include a portion of the instruction referred to as an opcode, which references/specifies an instruction or operation to be performed.

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

As depicted, cores 101 and 102 share access to higher-level or further-out cache 110, which is to cache recently fetched elements. Note that higher-level or further-out refers to cache levels increasing or getting further way from the execution unit(s). In one embodiment, higher-level cache 110 is a last-level data cache—last cache in the memory hierarchy on processor 100—such as a second or third level data cache. However, higher level cache 110 is not so limited, as it may be associated with or include an instruction cache. A trace cache—a type of instruction cache—instead may be coupled after decoder 125 to store recently decoded traces.

Note, in the depicted configuration that processor 100 also includes bus interface module 105 to communicate with devices external to processor 100, such as system memory 175, a chipset, a northbridge, or other integrated circuit. Memory 175 may be dedicated to processor 100 or shared with other devices in a system. Common examples of types of memory 175 include dynamic random access memory (DRAM), static RAM (SRAM), non-volatile memory (NV memory), and other known storage devices.

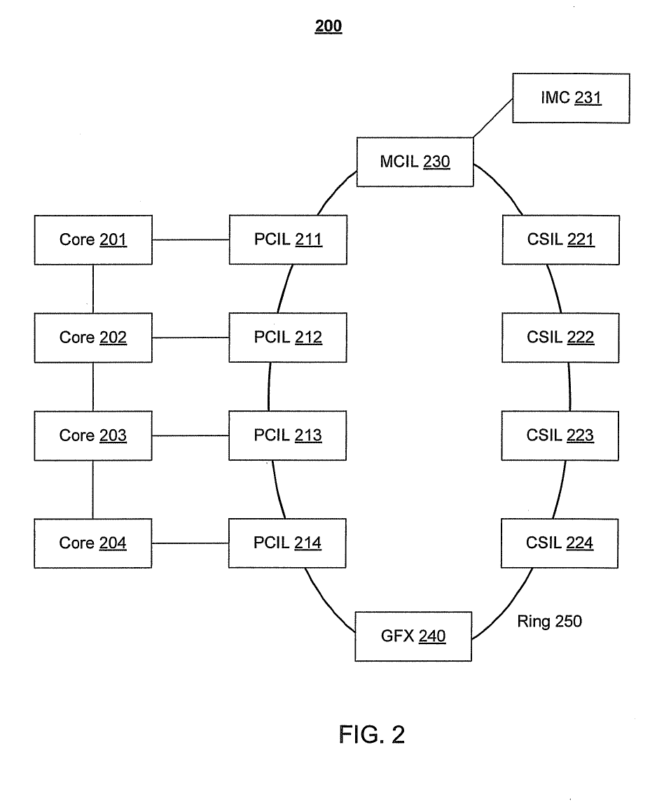

FIG. 1 illustrates an abstracted, logical view of an exemplary processor with a representation of different modules, units, and/or logic. However, note that a processor utilizing the methods and apparatus' described herein need not include the illustrated units. And, the processor may omit some or all of the units shown. To illustrate the potential for a different configuration, the discussion now turns to FIG. 2, which depicts an embodiment of processor 200 including an on-processor memory interface module—an uncore module—with a ring configuration to interconnect multiple cores. Processor 200 is illustrated including a physically distributed cache; a ring interconnect; as well as core, cache, and memory controller components. However, this depiction is purely illustrative, as a processor implementing the described methods and apparatus may include any processing elements, style or level of cache, and/or memory, front-side-bus or other interface to communicate with external devices.

In one embodiment, caching agents 221-224 are each to manage a slice of a physically distributed cache. As an example, each cache component, such as component 221, is to manage a slice of a cache for a co-located core—a core the cache agent is associated with for purpose of managing the distributed slice of the cache. As depicted, cache agents 221-224 are referred to as Cache Slice Interface Logic (CSIL)s; they may also be referred to as cache components, agents, or other known logic, units, or modules for interfacing with a cache or slice thereof. Note that the cache may be any level of cache; yet, for this exemplary embodiment, discussion focuses on a last-level cache (LLC) shared by cores 201-204.

Much like cache agents handle traffic on ring interconnect 250 and interface with cache slices, core agents/components 211-214 are to handle traffic and interface with cores 201-204, respectively. As depicted, core agents 221-224 are referred to as Processor Core Interface Logic (PCIL)s; they may also be referred to as core components, agents, or other known logic, units, or modules for interfacing with a processing element Additionally, ring 250 is shown as including Memory Controller Interface Logic (MCIL) 230 and Graphics Hub (GFX) 240 to interface with other modules, such as memory controller (IMC) 231 and a graphics processor (not illustrated). However, ring 250 may include or omit any of the aforementioned modules, as well as include other known processor modules that are not illustrated. Additionally, similar modules may be connected through other known interconnects, such as a point-to-point interconnect or a multi-drop interconnect.

It's important to note that the methods and apparatus' described herein may be implemented in any memory at any memory level, any cache at any cache level, or any processor at any processor level.

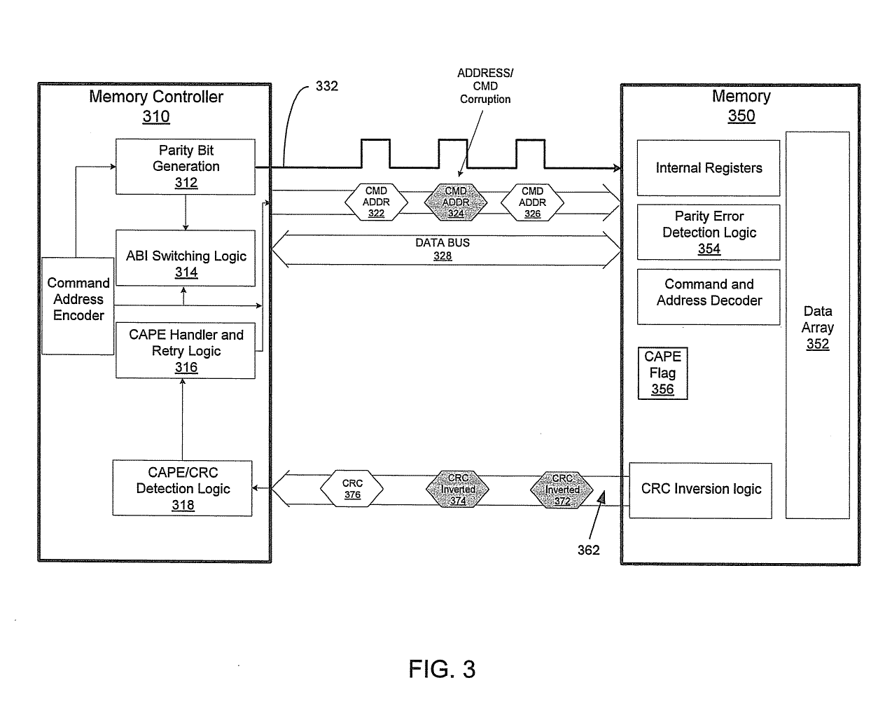

FIG. 3 illustrates a block diagram of a memory controller and memory according to an embodiment. Memory controller 310 may be a digital circuit which manages the flow of data going to and from an associated memory 350. The memory 350 may include a data array 352 to store data. Data read from and written to memory 350 may be transferred via data bus 328. The memory controller 310 may be part of a separate chip or integrated into another chip, such as on the die of a microprocessor. The memory controller 310 may manage the flow of data from/to memory 350 by sending read/write commands for data along with the corresponding memory addresses (322-326). When sending the command/address information 322-326, bit corruptions are possible where one or more bits from the command/address information may be inverted (i.e., a 1 may be inverted to a 0 or vice-versa), which may consequently lead to incorrect data retrieved from and/or stored to the data array 352 of memory 350. Command/address bit corruption may occur due to various reasons including crosstalk, radiation, and process voltage temperature variations. The probability of bit corruption may increase as the data transfer rate between the memory controller 310 and the memory 350 increases. For example, the probability of bit corruptions may significantly increase in high speed memories such as graphic double data rate 5 (GDDR5) memories.

Errors in the data array 352 may be minimized by detecting and correcting command/address corruptions. Specifically, a parity bit generation module 312 within memory controller 310 may calculate a parity bit for each command and/or address. The memory controller 310 may then transmit this parity bit associated with each command/address to the memory 350. The memory 350 may include a parity error detection logic 354 to calculate a parity bit for each incoming command and/or address and compare the calculated parity bit with the parity bit sent by the memory controller 310. If the calculated parity bit matches the incoming parity bit, the parity error detection logic 354 may determine that the possibility of bit inversion in the command/address is minimal. However, if there is a parity bit mismatch, the parity error detection logic 354 may signal a command address parity error (CAPE) so that necessary steps may be taken to correct and recover from the detected CAPE.

Certain memory devices may not include native support for transmitting parity information. For example, GDDR5 memories which were initially built for use in graphics processors do not include dedicated pins on chip, board, and memory to transmit parity bits. Therefore, in an embodiment, parity bits may be transmitted on available I/O interfaces such as the address bus inversion (ABI) pin 332. The ABI switching logic 314 may determine that parity information has a higher priority over ABI information, and thus may signal that the ABI pin is to be used for the transmission of parity information instead of ABI information.

In an embodiment, when a CAPE is detected at memory 350, the erroneous command may be ignored and the data array 352 may be locked so that no further operations may be performed on the data array 352 until it is unlocked. In an embodiment, internal to the memory 350, a CAPE flag 356 may be set to indicate that the data array 352 is locked. The memory 350 may then relay the CAPE error to the memory controller 310. In response, the memory controller 310 may send a CAPE unlock signal to the memory 350 to unlock data array 352 and retry all transactions which were not processed by the memory 350 due to the locking of the data array 352.

Certain memory devices may not include native support for transmitting CAPE information. For example, GDDR5 memories do not include dedicated pins to transmit CAPE information. Therefore, in an embodiment, CAPE information may be transmitted through error detection and correction (EDC) pins 362 normally used for transmitting cyclic redundancy check (CRC) checksums. Typically for every read/write transaction, a CRC checksum of the read/write transaction data is transmitted via the EDC pins 362 to the memory controller 310. If the CRC checksum does not match the expected CRC checksum at the memory controller 310, the memory controller 310 may include logic to correct the error (for example, logic to retry the operation associated with the mismatched checksum).

In an embodiment, when a CAPE is detected, the checksum corresponding to the transaction triggering the CAPE may be inverted and sent to the memory controller 310. In addition, the checksums for any transactions received after the data array 352 is locked may also be inverted and sent to the memory controller 310. Inverting a checksum may involve changing the 1 bits from the checksum to 0 bits and changing the 0 bits from the checksum to 1 bits. For example, inverting a checksum of 10001 may result in an inverted checksum of 01110. The memory controller 310 may include CAPE/CRC detection logic 318 to detect whether an incoming CRC checksum is an indication of a CAPE or a CRC error. In an embodiment the CAPE/CRC detection logic 318 may determine that a CAPE occurred if the incoming checksum is inverted. In response, CAPE handler logic 316 may block all future processing by the memory controller 310, drain already processed commands, and wait for the processed commands' CRC checksums. For each inverted CRC checksum, the CAPE handler logic 316 may mark the associated transactions for retry. The CAPE handler logic may then clear all page information of memory controller 310 and send a CAPE unlock command to the memory 350. Upon receipt of the CAPE unlock command, the memory 350 may clear the CAPE flag, and may unlock the data array 352. The CAPE retry logic 316 then retries all the transactions marked for retry in the order of arrival of the inverted CRC checksums (these are the transactions which previously failed because of the CAPE). The memory controller 310 may then continue normal operation with regards to future transactions until another error is encountered.

In an example embodiment three transactions may be sent from the memory controller 310 to memory 350. The corresponding commands/addresses for the three transactions may be 322-326. For each command/address 322-326, the parity bit generation logic 312 may send an associated parity bit via the ABI pin 332. The memory 350 may first receive command/address 326 and the parity error detection logic 354 may check command/address 326's parity bit and determine that there is no parity error. The transaction associated with command/address 326 may then be processed memory 350. The memory 350 may calculate a CRC checksum 376 for the data associated with the transaction and send the checksum via the EDC pin 362 to the memory controller 310. The CAPE/CRC detection logic 318 may examine the checksum 376 and resolve that the checksum 376 matches a checksum calculated on the memory controller's end. Thus, the CAPE/CRC detection logic 318 may determine that no CAPE occurred since the checksum 376 was not inverted, and normal processing may continue.

The memory 350 may then receive command/address 324 and the parity error detection logic 354 may check command/address 324's parity bit and detect a CAPE. Therefore, the data array 352 may be locked, the CAPE flag may be set, and the transaction associated with command/address 324 may be ignored. The memory 350 may calculate a CRC checksum for the data associated with the transaction, invert the checksum, and send the inverted checksum 374 via the EDC pin 362 to the memory controller 310. The CAPE/CRC detection logic 318 may examine the inverted checksum 374 and determine that the inverted checksum 374 matches an inversion of a checksum calculated on the memory controller's end. Thus, the CAPE/CRC detection logic 318 may determine that a CAPE occurred. In response, CAPE handler logic 316 may block all future processing by the memory controller 310, drain already processed commands, and wait for the processed commands' CRC checksums.

The memory 350 may then receive command/address 322. Since the memory 350 is already operating under a CAPE mode, the transaction associated with command/address 322 may be ignored. The memory 350 may calculate a CRC checksum for the data associated with the transaction, invert the checksum, and send the inverted checksum 372 via the EDC pin 362 to the memory controller 310. The CAPE/CRC detection logic 318 may examine the inverted checksum 374 and determine that the inverted checksum 374 matches an inversion of a checksum calculated on the memory controller's end. For each inverted CRC checksum 374 and 372, the CAPE handler logic 316 may mark the associated transactions for retry. The CAPE handler logic may then clear all page information of memory controller 310 and send a CAPE unlock command to the memory 350. Upon receipt of the CAPE unlock command, the memory 350 may clear the CAPE flag, and may unlock the data array 352. The CAPE retry logic 316 then may retry all the transactions marked for retry in the order of arrival of the inverted CRC checksums. Specifically, the transaction associated with command/address 324 and then the transaction associated with command/address 322 may be retried. The memory controller 310 may then continue normal operation with regards to future transactions until another error is encountered.

In an embodiment, the parity information may be calculated by utilizing any combination of address and command bits. In an embodiment, the parity information may be carried by the ABI pin 332 on both the high phase of a command clock and the low phase of the command clock. For example, a memory such as GDDR5 memory may include four bank address bits (BA0-BA3), thirteen address bits (A0-A12), a bit reserved for future use (RFU), a row address store bit (RAS), a column address store bit (CAS), and a write-enable bit (WE). On the high phase of the command clock, parity information calculated from: BA3̂BA2̂BA1̂BA0̂A12̂A11̂A10̂A9̂A8̂RAŜCAŜWE may be sent, and on the low phase of the command clock, parity information calculated from: A0̂A1̂A2̂A3̂A4̂A5̂A6̂A7̂RFÛRAŜCAŜWE may be sent.

In an embodiment, the memory controller 310 may be set up by a combination of fuse and control register (CR) to enable CAPE handling. The memory controller 310 may enable CAPE detection in the memory 350 during the initialization phase after training the I/O pins. In an embodiment, all commands interacting with the data array 352 may be CAPE protected. The commands may include read, write, precharge (PRE), precharge all (PREALL), and activate (ACT). The ACT command may activate rows in a memory bank by loading them into a sense amplifier. The PRE command may deactivate one or more rows in a memory bank by writing charges back from the sense amplifier to the memory bank. The PREALL command may write charges from all sense amplifiers back to the corresponding memory banks.

Error-correcting code (ECC) memory is a type of memory which can detect and correct common kinds of internal data corruption. In addition to storing data, ECC memories store ECC information associated with the data which can help detect and correct errors in the data. However, certain memory devices do not include native ECC support and are consequently not appropriate for applications where errors in data cannot be tolerated. Therefore, in an embodiment, efficient ECC support may be added to non-ECC memory devices such as GDDR5.

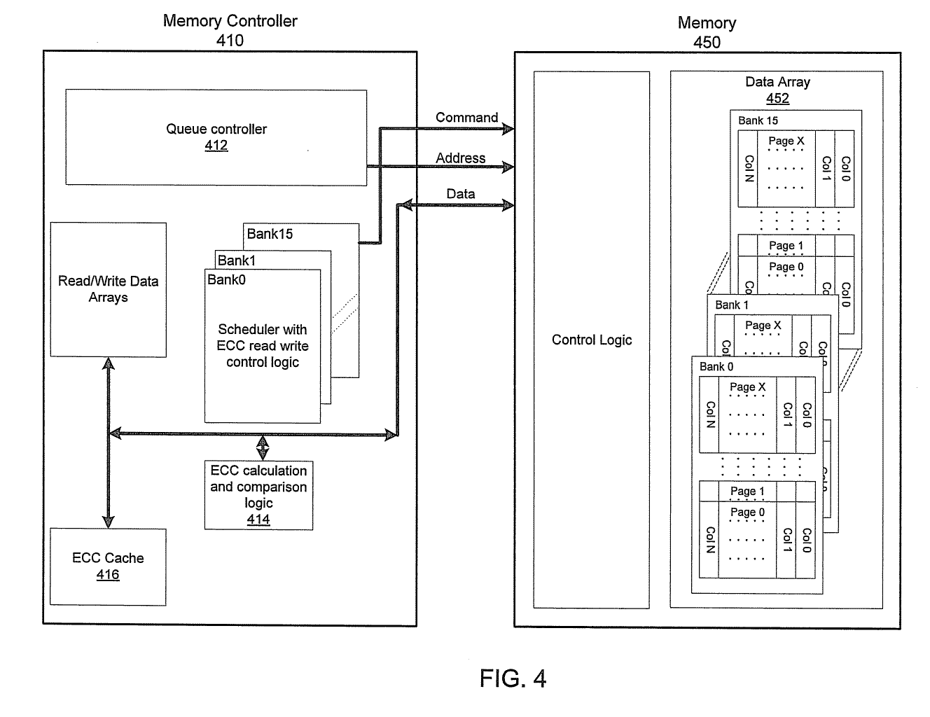

FIG. 4 illustrates a memory controller and memory according to an embodiment. The memory 450 may include a data array 452 to store data and ECC information. Memory controller 410 may be a digital circuit which manages the flow of data and ECC information going to and from the associated memory 450. The data array 452 may be organized into independent memory banks with a number of rows (or memory pages). A particular physical memory address may be broken down into bank, row, and column for accessing memory 450. The number of banks, rows, and columns may vary based on the type of memory. To read or write a column in a page, the memory controller 410 may first issue an ACT command to open the associated page into the memory 450's internal sense amplifier associated with the bank which holds the page. Then, a single column address strobe (CAS) command may be issued which addresses that particular column.

The memory controller 410 may include a queue controller 412 to control the ordering and flow of read/write transactions to memory 450, a physical array used as an ECC cache 416, and ECC calculation and comparison logic 414. The ECC cache 416 may hold values calculated by the ECC calculation logic 414 for writes and ECC values fetched from the data array 452 for reads.

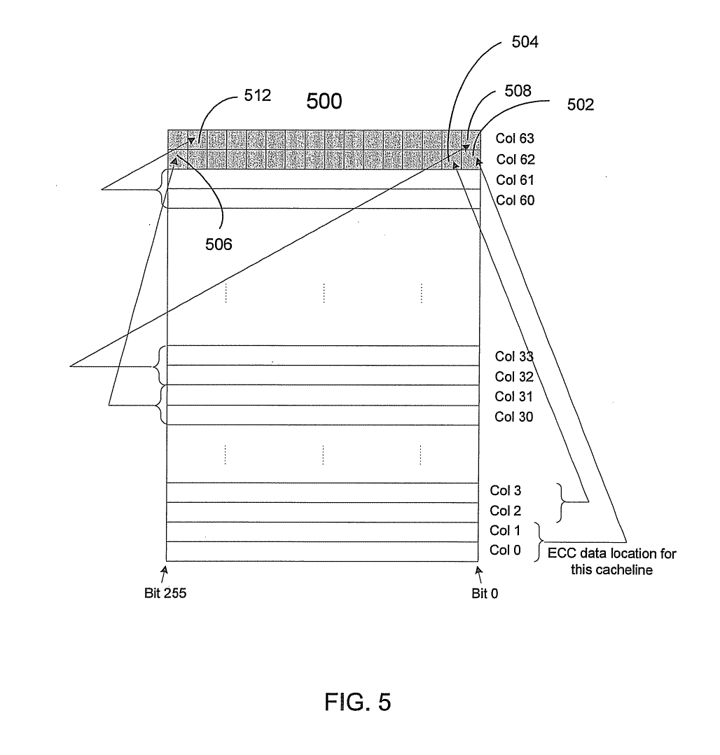

FIG. 5 illustrates a page from a memory bank in a memory data array, such as data array 452, according to an embodiment. In an embodiment, page 500 may be part of a memory device such as GDDR5 memory. In a non-clamshell (×32) system, a GDDR5 memory bank may include 2¹³ pages. Each page 500 may include a total of 64 columns (column 0-63), and each column 0-63 may include 255 bits.

In an embodiment, space for ECC information may be reserved on the same page 500 as the associated data to increase performance. The amount of space reserved may depend on the algorithm used to generate the ECC information. For example, in an embodiment, extended single error correction, double error detection (SECDED) Hamming code may be used. The number of ECC check bits needed to code a cache line may depend on the size of the cache line. In turn, the size of the cache line may depend on the processor(s) accessing data from memory. For example, Intel's high performance coprocessors have a cache line size of 512 bits. The ECC code for a 512 bit cache line may be 11 bits. In an embodiment, the space reserved to store the ECC information of a single data cache line of 512 bits may be 11 bits rounded to the closest power of two, i.e., 16 bits. In an embodiment, the space reserved for ECC information of all the data cache lines on a memory page may be the minimum ECC space needed rounded to the closest cache line size. In an embodiment, the space for data and associated ECC information may be partitioned so that the space usage on the page 500 is efficiently allocated. For example, in an embodiment, 31 cache lines (62 columns) may be reserved for data and the remaining 1 cache line (2 columns) may be reserved for the associated ECC information.

In an embodiment, the first 31 cache lines (columns 0-61) of the page 500 may be reserved for data and the last cache line (columns 62-63) may be reserved for the associated ECC information. In an embodiment, the ECC information associated with the data stored in columns 0 and 1 (the first cache line) may be stored in the first 16 bits 502 of the space reserved for ECC information (i.e., bits 0-15 of column 62). Similarly, the ECC information associated with the data stored in columns 2 and 3 (the second cache line) may be stored in the second 16 bits 504 of the space reserved for ECC information (i.e., bits 16-31 of column 62). The remaining data and associated ECC information may be stored in a similar manner. For example, the ECC information associated with the data stored in columns 30 and 31 may be stored in the last 16 bits 506 of column 62. The ECC information associated with the data stored in columns 32 and 33 may be stored in the first 16 bits 508 of column 63. The ECC information associated with the data stored in columns 60 and 61 may be stored in the fifteenth 16 bits 512 of column 63.

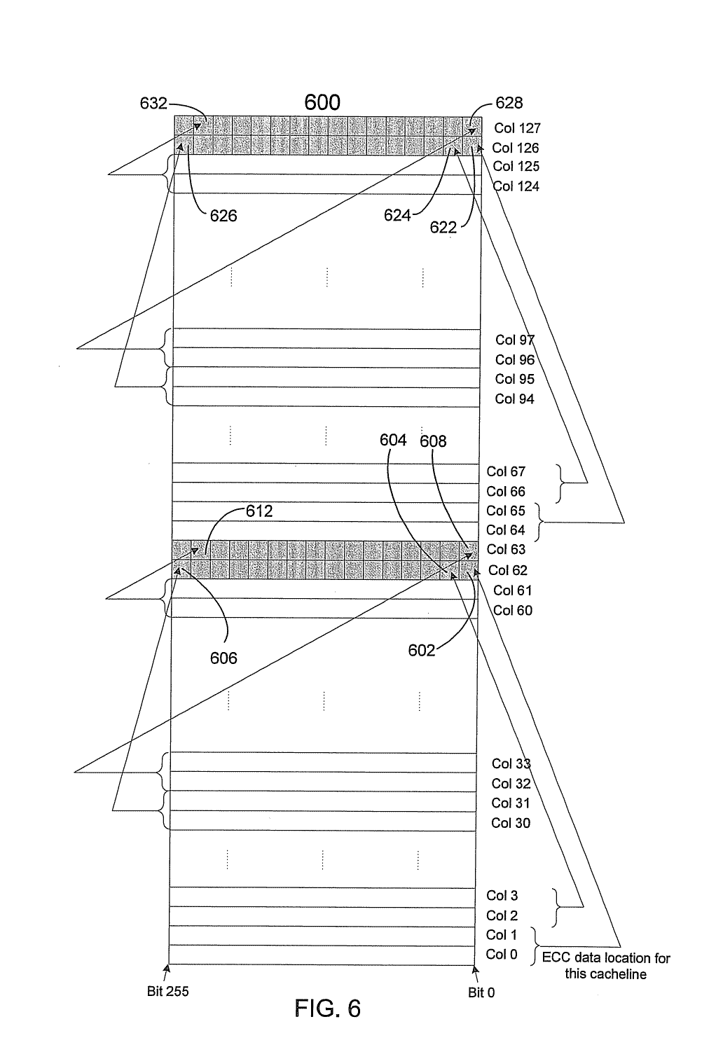

FIG. 6 illustrates a page from a memory bank in a memory data array, such as data array 452 (FIG. 4), according to an embodiment. In an embodiment, page 600 may be part of a memory device such as GDDR5 memory. In a clamshell (×16) system, a GDDR5 memory bank may include 2¹³ pages. Each page 600 may include a total of 128 columns (column 0-127), and each column 0-127 may include 255 bits.

In an embodiment, space for ECC information may be reserved on the same page 600 as the associated data to increase performance. The amount of space reserved may depend on the algorithm used to generate the ECC information. For example, in an embodiment, extended single error correction, double error detection (SECDED) Hamming code may be used. The number of ECC check bits needed to code a cache line may depend on the size of the cache line. For example, the ECC code for a 512 bit cache line may be 11 bits. In an embodiment, the space reserved to store the ECC information of a single cache line of 512 bits may be 11 bits rounded to the closest power of two, i.e., 16 bits. In an embodiment, the space reserved for ECC information of all the data cache lines on a memory page may be the minimum ECC space needed rounded to the closest cache line size. In an embodiment, the space for data and associated ECC information may be partitioned so that the space usage on the page 600 is efficiently allocated. For example, in an embodiment, 62 cache lines (124 columns) may be reserved for data and the remaining 2 cache lines (4 columns) may be reserved for the associated ECC information.

In an embodiment, the first 31 cache lines (columns 0-61) of the page 600 may be reserved for data and the 32^{nd} cache line (columns 62-63) may be reserved for the associated ECC information. In an embodiment, the ECC information associated with the data stored in columns 0 and 1 (the first cache line) may be stored in bits 0-15 (602) of column 62. Similarly, the ECC information associated with the data stored in columns 2 and 3 (the second cache line) may be stored in bits 16-31 (604) of column 62. The remaining data and associated ECC information may be stored in a similar manner. For example, the ECC information associated with the data stored in columns 30 and 31 may be stored in the last 16 bits 606 of column 62. The ECC information associated with the data stored in columns 32 and 33 may be stored in the first 16 bits 608 of column 63. The ECC information associated with the data stored in columns 60 and 61 may be stored in the fifteenth 16 bits 612 of column 63.

In an embodiment, cache lines 33-63 (columns 64-125) of the page 600 may be reserved for data and the 64^{th} cache line (columns 126-127) may be reserved for the associated ECC information. In an embodiment, the ECC information associated with the data stored in columns 64 and 65 (the 33^{rd} cache line) may be stored in bits 0-15 (622) of column 126. Similarly, the ECC information associated with the data stored in columns 66 and 67 (the 34^{th} cache line) may be stored in bits 16-31 (624) of column 126. The remaining data from columns 68-125 and the associated ECC information may be stored in a similar manner. For example, the ECC information associated with the data stored in columns 94 and 95 may be stored in the last 16 bits 626 of column 126. The ECC information associated with the data stored in columns 96 and 97 may be stored in the first 16 bits 628 of column 127. The ECC information associated with the data stored in columns 124 and 125 may be stored in the fifteenth 16 bits 632 of column 127.

In an embodiment, as seen in FIGS. 5 and 6, the storage structure of a page 600 in a clamshell system may be similar to the storage structure of two pages 500 in a non-clamshell system. Therefore, the logic used to access data and ECC information in a clamshell system may be analogous to the logic used to access data and ECC information in a non-clamshell system. The major difference being that in a clamshell system, the logic needs to determine first whether the first half (columns 0-63) or the second half (columns 64-127) is accessed.

A person having ordinary skill in the art will appreciate that the principles of the present invention are not limited to the exact distribution of ECC information and data as discussed in FIGS. 5 and 6. In other embodiments the ECC information may be organized differently.

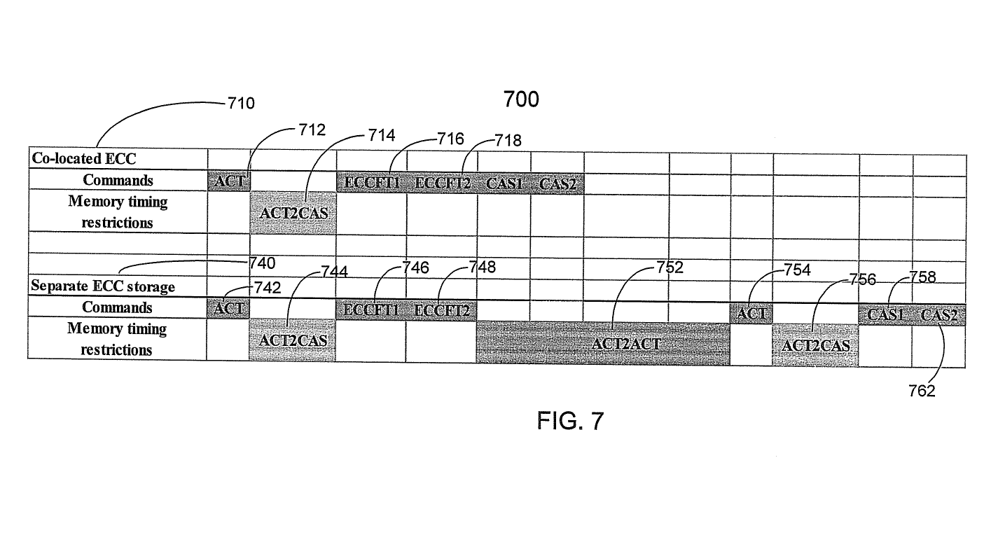

FIG. 7 illustrates a chart 700 comparing memory access times of a co-located data and ECC memory configuration according to an embodiment and a non-co-located data and ECC memory configuration. Storing the ECC information on the same page as the associated data may avoid large latency penalties in opening and closing pages to a completely separate ECC address space. On write transactions, ECC information may be calculated for the associated data and written to memory using CAS commands (i.e., the command to address a column in a memory page) after writing the associated data. This may be referred to as ECC write backs (ECCWB). Similarly, on reads, the ECC information for the associated read data may be fetched from memory using CAS commands. This may be referred to as ECC fetches (ECCFT).

As explained previously, prior to executing a CAS command to access a column, an ACT command has to be executed to first open the page containing that particular column. There is usually a minimum time delay (ACT2CAS) when transitioning from an ACT command to a CAS command. Similarly, there is a minimum time delay (ACT2ACT) when transitioning from an ACT command to another ACT command. Typically, the ACT2ACT delay is three times as long as an ACT2CAS delay.

Chart 700 shows a table 710 illustrating the time required to read data from two columns in a memory system where the data and the associated ECC information are co-located on the same memory page (as discussed in FIGS. 5 and 6), and a table 740 illustrating the time required to read data from two columns in a memory system where the data and the associated ECC information are stored on separate memory pages. As seen in table 740, in a memory system where data and associated ECC information are not co-located, an ACT command 742 may be first executed to open the page with the ECC information. Next, the system may have to wait an ACT2CAS period of time 744 to execute an ECCFT command 746 to retrieve the ECC information associated with the first column of read data. The system may then execute a second ECCFT command 748 to retrieve the ECC information associated with the second column of read data. After waiting for a relatively long ACT2ACT period of time 752, the system may execute the next ACT command 754 to open the page with the data. Next, the system may have to wait an ACT2CAS period of time 756 to execute a CAS command 758 to retrieve the data from the first column. The system may then execute a second CAS command 762 to retrieve the data from the second column.

As seen in table 710, in a memory system where data and associated ECC information are co-located, an ACT command 712 may be first issued to open the page with the ECC information and data. Next, the system may have to wait an ACT2CAS period of time 714 to execute an ECCFT command 716 to retrieve the ECC information associated with the first column of read data. The system may then execute a second ECCFT command 718 to retrieve the ECC information associated with the second column of read data. The system may then execute two CAS commands to retrieve the data from the first and second columns. Comparing table 740 to table 710 illustrates the extra time penalties and operations incurred when the data and ECC information are not co-located on the same memory page. As a result of opening a separate page with the data an ACT2ACT delay 752 and an additional ACT2CAS delay 756 are incurred. Furthermore, an additional ACT command 754 has to be executed to open the page with the data. Thus, keeping the data and the associated ECC information on the same page may yield a significant performance gain, especially with the execution of multiple read/write transactions.

In addition to storing the data and associated ECC information on the same memory page, ECC information may be cached on the memory controller's end. In situations where data transactions exhibit strong temporal and spatial locality, the memory controller may be configured to operate in an open page mode. Upon activating (opening) a page for a read/write transaction, all ECC information from the activated page may be cached in the memory controller's ECC cache. The page may be left open so that the memory is not accessed to retrieve/write ECC information for consecutive successive data transactions. For read transactions the ECC information may be read directly from the memory controller's ECC cache. For write transactions, the associated ECC information may be updated in the ECC cache and all the ECC information in the cache may be written back to the memory page when the page is closed (the page may be closed, for example, when a successive data transaction needs to open another memory page).

However, the open page mode may not be efficient when consecutive data transactions access random data pages and/or the ECC information in each page is so large that multiple ECCFT commands need to issued to load the ECC information into the ECC cache. Therefore, in an embodiment, the memory controller may be configured to operate in a closed page mode. In the closed page mode, the ECC information is not cached by the memory controller, and ECC is written after each write and read before each read transaction. On every access the page is closed.

In a further embodiment, the memory controller may operate in a hybrid open page mode. In the hybrid open page mode, only the minimum number of columns with ECC information is accessed. For each read transaction, only the ECC column(s) associated with the read data is loaded into the memory controller's ECC cache if those particular ECC column(s) are not already present in the ECC cache. Similarly, for each write transaction, the ECC column(s) associated with the transactions are written to the ECC cache, and when the page is closed, only the ECC column(s) in the ECC cache are written back into memory.

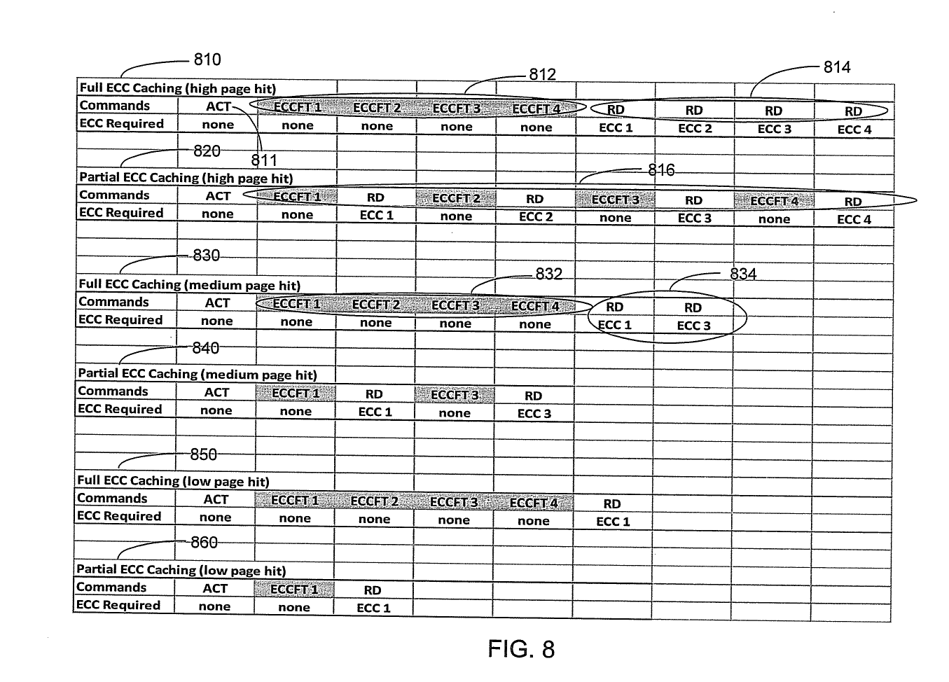

FIG. 8 illustrates a chart 800 comparing memory operations in open page mode and hybrid open page mode according to an embodiment. Chart 800 presents six tables 810, 820, 830, 840, 850, and 860. The tables present exemplary memory operations needed for read transactions during different levels of memory page accesses. The exemplary memory operations are shown for an exemplary memory page with four columns of ECC information and the associated data residing on the same memory page. Table 810 presents exemplary memory operations in open page mode for read transactions where the entire ECC information in the memory page is utilized. Table 820 presents exemplary memory operations in hybrid open page mode for read transactions where the entire ECC information in the memory page is utilized. Table 830 presents exemplary memory operations in open page mode for read transactions where 50% of the ECC information in the memory page is utilized. Table 840 presents exemplary memory operations in hybrid open page mode for read transactions where 50% of the ECC information in the memory page is utilized. Table 850 presents exemplary memory operations in open page mode for read transactions where 25% of the ECC information in the memory page is utilized. Table 860 presents exemplary memory operations in hybrid open page mode for read transactions where 25% of the ECC information in the memory page is utilized.

As seen in tables 810 and 820, when all the data from a memory page is read, the same number of memory operations are executed in both open page mode and hybrid open page mode. Only the ordering of the operations differ. Specifically, in open page mode (table 810), upon activating 811 the memory page for the read transactions, all four ECC columns from the memory page are read 812 and loaded into the ECC cache. Then the associated data is read 814. In hybrid open page mode (table 820), each ECC column is read right before fetching the associated data 816. Since data associated with ECC information from the four ECC columns is read, all four ECC columns from the memory page are also read, resulting in the same number of memory operations as the open page mode.

However, as seen in tables 830, 840, 850, and 860, if less than 100% of the ECC information is utilized, the hybrid open page mode may be more efficient than the open page mode. For example, in open page mode (table 830), upon activating the memory page for the read transactions, all four ECC columns from the memory page are read 832 and loaded into the ECC cache. Then data associated with only two of the ECC columns is read 834. Therefore, two of the ECC columns were fetched unnecessarily. As shown in table 840, the two ECC columns which are needed are not fetched in hybrid open page mode, resulting in 50% less ECCFTs than the open page mode. Similarly, as seen in tables 850 (open page mode) and 860 (hybrid open page mode), if only 25% of the ECC information is utilized, the hybrid open page mode avoids fetching three unnecessary ECC columns, resulting in 75% less ECCFTs than the open page mode.

Although some of the above figures and corresponding discussions are explained using examples pertaining to GDDR5 memory for illustrative purposes, a person having ordinary skill in the art will appreciate that the principles of the present invention are not limited to GDDR5 memory. The principles of the present invention are applicable to various types of memory and memory controllers.

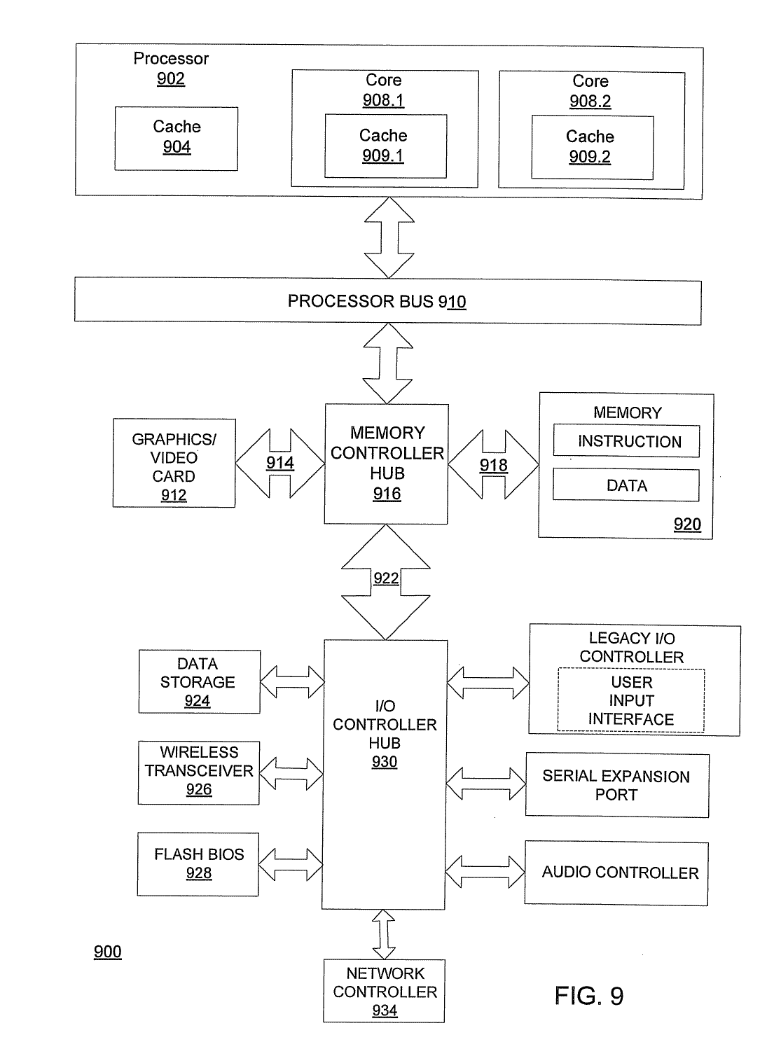

FIG. 9 is a block diagram of an exemplary computer system 900 formed with a processor 902 that includes one or more cores 908 (e.g., cores 908.1 and 908.2). Each core 908 may execute an instruction in accordance with one embodiment of the present invention. System 900 includes a component, such as a processor 902 to employ execution units including logic to perform algorithms for process data, in accordance with the present invention. System 900 is representative of processing systems based on the PENTIUM® III, PENTIUM® 4, Xeon™, Itanium®, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 900 may execute a version of the WINDOWS™ operating system available from Microsoft Corporation of Redmond, Wash., although other operating systems (UNIX and Linux for example), embedded software, and/or graphical user interfaces, may also be used. Thus, embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

One embodiment of the system 900 may be described in the context of a single processor desktop or server system, but alternative embodiments can be included in a multiprocessor system. System 900 may be an example of a ‘hub’ system architecture. The computer system 900 includes a processor 902 to process data signals. The processor 902 can be a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 902 is coupled to a processor bus 910 that can transmit data signals between the processor 902 and other components in the system 900. The elements of system 900 perform their conventional functions that are well known to those familiar with the art.

Depending on the architecture, the processor 902 can have a single internal cache or multiple levels of internal cache. Alternatively, in another embodiment, the cache memory can reside external to the processor 902. Other embodiments can also include a combination of both internal and external caches depending on the particular implementation and needs. In one embodiment, the processor 902 may include a Level 2 (L2) internal cache memory 904 and each core (e.g., 908.1 and 908.2) may include a Level 1 (L1) cache (e.g., 909.1 and 909.2, respectively). In one embodiment, the processor 902 may be implemented in one or more semiconductor chips. When implemented in one chip, all or some of the processor 902's components may be integrated in one semiconductor die.

Each of the core 908.1 and 908.2 may also include respective register files (not shown) that can store different types of data in various registers including integer registers, floating point registers, status registers, and instruction pointer register. Each core 908 may further include logic to perform integer and floating point operations.

The processor 902 also includes a microcode (ucode) ROM that stores microcode for certain macroinstructions. For one embodiment, each core 908 may include logic to handle a packed instruction set (not shown). By including the packed instruction set in the instruction set of a general-purpose processor 902, along with associated circuitry to execute the instructions, the operations used by many multimedia applications may be performed using packed data in a general-purpose processor 902. Thus, many multimedia applications can be accelerated and executed more efficiently by using the full width of a processor's data bus for performing operations on packed data. This can eliminate the need to transfer smaller units of data across the processor's data bus to perform one or more operations one data element at a time.

Alternate embodiments of the processor 902 can also be used in micro controllers, embedded processors, graphics devices, DSPs, and other types of logic circuits. System 900 includes a memory 920. Memory 920 can be a dynamic random access memory (DRAM) device, a static random access memory (SRAM) device, flash memory device, or other memory device. Memory 920 can store instructions and/or data represented by data signals that can be executed by the processor 902.

A system logic chip 916 is coupled to the processor bus 910 and memory 920. The system logic chip 916 in the illustrated embodiment is a memory controller hub (MCH). The processor 902 can communicate to the MCH 916 via a processor bus 910. The MCH 916 provides a high bandwidth memory path 918 to memory 920 for instruction and data storage and for storage of graphics commands, data and textures. The MCH 916 is to direct data signals between the processor 902, memory 920, and other components in the system 900 and to bridge the data signals between processor bus 910, memory 920, and system I/O 922. In some embodiments, the system logic chip 916 can provide a graphics port for coupling to a graphics controller 912. The MCH 916 is coupled to memory 920 through a memory interface 918. The graphics card 912 may be coupled to the MCH 916 through an Accelerated Graphics Port (AGP) interconnect 914.

System 900 uses a proprietary hub interface bus 922 to couple the MCH 916 to the I/O controller hub (ICH) 930. The ICH 930 provides direct connections to some I/O devices via a local I/O bus. The local I/O bus is a high-speed I/O bus for connecting peripherals to the memory 920, chipset, and processor 902. Some examples are the audio controller, firmware hub (flash BIOS) 928, wireless transceiver 926, data storage 924, legacy I/O controller containing user input and keyboard interfaces, a serial expansion port such as Universal Serial Bus (USB), and a network controller 934. The data storage device 924 can comprise a hard disk drive, a floppy disk drive, a CD-ROM device, a flash memory device, or other mass storage device.

For another embodiment of a system, an instruction in accordance with one embodiment can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip.

A value, as used herein, includes any known representation of a number, a state, a logical state, or a binary logical state. Often, the use of logic levels, logic values, or logical values is also referred to as 1s and 0s, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

The embodiments of methods, hardware, software, firmware or code set forth above may be implemented via instructions or code stored on a machine-accessible or machine readable medium which are executable by a processing element. A machine-accessible/readable medium includes any mechanism that provides (i.e., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash memory devices; electrical storage device, optical storage devices, acoustical storage devices or other form of propagated signal (e.g., carrier waves, infrared signals, digital signals) storage device; etc. For example, a machine may access a storage device through receiving a propagated signal, such as a carrier wave, from a medium capable of holding the information to be transmitted on the propagated signal.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A method comprising:
receiving a command and an address associated with a data transaction;
receiving parity information associated with at least one of the command and address;
in response to detecting a parity error based on the parity information, locking a data array of a memory device; and
sending an indicator indicating the parity error.

2. The method of claim 1, wherein the parity information is received through at least an address bus inversion pin.

3. The method of claim 1, further comprising:
setting a command address parity error flag in response to detecting the parity error.

4. The method of claim 1, wherein the sending the indicator includes sending an inverted cyclic redundancy check code of the data transaction.

5. The method of claim 4, wherein the inverted cyclic redundancy check code is sent through at least an error detection and correction pin.

6. The method of claim 1, further comprising:
in response to receiving a command address parity error unlock command, unlocking the data array.

7. A method comprising:
in response to receiving an inverted cyclic redundancy check code of a data transaction, halting processing of incoming data transactions;
sending a command address parity error unlock command; and
re-sending the data transaction.

8. A method comprising:
reserving a first portion of a memory page to store data;
reserving a second portion of the memory page to store error correction codes associated with the data, wherein the second portion's size equals or exceeds error correction code capacity needed for maximum possible data stored in the first portion;
storing a cache line of data in the first portion; and
storing an error correction code associated with the cache line of data in the second portion.

9. The method of claim 8, further comprising:
in response to a read request of the cache line of data, fetching the error correction code from the second portion;
caching the error correction code; and
fetching the cache line of data from the first portion.

10. An apparatus comprising:
a memory device to:
receive a command and an address associated with a data transaction;
receive parity information associated with at least one of the command and address;
in response to detecting a parity error based on the parity information, lock a data array of the memory device; and
send an indicator indicating the parity error.

11. The apparatus of claim 10, wherein the parity information is received through at least an address bus inversion pin.

12. The apparatus of claim 10, wherein the memory device is further configured to set a command address parity error flag in response to detecting the parity error.

13. The apparatus of claim 10, wherein the memory device sends the indicator by sending an inverted cyclic redundancy check code of the data transaction.

14. The apparatus of claim 13, further comprising:
an error detection and correction pin to send the inverted cyclic redundancy check code.

15. The apparatus of claim 10, wherein the memory device is further configured to unlock the data array in response to receiving a command address parity error unlock command.

16. An apparatus comprising:
a memory controller to:
halt processing of incoming data transactions, in response to receiving an inverted cyclic redundancy check code of a data transaction;
send a command address parity error unlock command; and
re-send the data transaction.

17. An apparatus comprising:
a processor to execute computer instructions, wherein the processor is configured to:
receive a command and an address associated with a data transaction;
receive parity information associated with at least one of the command and address;
in response to detecting a parity error based on the parity information, lock a data array of a memory device; and
send an indicator indicating the parity error to a memory controller.

18. The apparatus of claim 17, wherein the parity information is received through at least an address bus inversion pin.

19. The apparatus of claim 17, wherein the processor is further configured to set a command address parity error flag in the memory device in response to detecting the parity error.

20. The apparatus of claim 17, wherein the processor sends the indicator by sending an inverted cyclic redundancy check code of the data transaction.

21. The apparatus of claim 20, wherein the inverted cyclic redundancy check code is sent through at least an error detection and correction pin.

22. The apparatus of claim 17, wherein the processor is further configured to unlock the data array in response to receiving a command address parity error unlock command.

23. An apparatus comprising:
a processor to execute computer instructions, wherein the processor is configured to:
in response to receiving an inverted cyclic redundancy check code of a data transaction, halt processing of incoming data transactions at a memory controller;
send a command address parity error unlock command to a memory device; and
re-send the data transaction to the memory device.

24. An apparatus comprising:
a processor to execute computer instructions, wherein the processor is configured to:
reserve a first portion of a memory page to store data;
reserve a second portion of the memory page to store error correction codes associated with the data, wherein the second portion's size equals or exceeds error correction code capacity needed for maximum possible data stored in the first portion;
store a cache line of data in the first portion; and
store an error correction code associated with the cache line of data in the second portion.

25. The apparatus of claim 24, wherein the processor is further configured to fetch the error correction code from the second portion in response to a read request of the cache line of data;
cache the error correction code; and
fetch the cache line of data from the first portion.

26. A non-transitory machine-readable medium having stored thereon an instruction, which if performed by a machine causes the machine to perform a method comprising:
receiving a command and an address associated with a data transaction;
receiving parity information associated with at least one of the command and address;
in response to detecting a parity error based on the parity information, locking a data array of a memory device; and
sending an indicator indicating the parity error.

27. The machine-readable medium of claim 26, wherein the parity information is received through at least an address bus inversion pin.

28. The machine-readable medium of claim 26, wherein the method further comprises:
setting a command address parity error flag in response to detecting the parity error.

29. The machine-readable medium of claim 26, wherein the sending the indicator includes sending an inverted cyclic redundancy check code of the data transaction.

30. The machine-readable medium of claim 29, wherein the inverted cyclic redundancy check code is sent through at least an error detection and correction pin.

31. The machine-readable medium of claim 26, wherein the method further comprises:
in response to receiving a command address parity error unlock command, unlocking the data array.

32. A non-transitory machine-readable medium having stored thereon an instruction, which if performed by a machine causes the machine to perform a method comprising:
in response to receiving an inverted cyclic redundancy check code of a data transaction, halting processing of incoming data transactions;
sending a command address parity error unlock command; and
re-sending the data transaction.

33. A non-transitory machine-readable medium having stored thereon an instruction, which if performed by a machine causes the machine to perform a method comprising:
reserving a first portion of a memory page to store data;
reserving a second portion of the memory page to store error correction codes associated with the data, wherein the second portion's size equals or exceeds error correction code capacity needed for maximum possible data stored in the first portion;
storing a cache line of data in the first portion; and
storing an error correction code associated with the cache line of data in the second portion.

34. The machine-readable medium of claim 33, wherein the method further comprises:
in response to a read request of the cache line of data, fetching the error correction code from the second portion;
caching the error correction code; and
fetching the cache line of data from the first portion.
